(19) United States
(12) Patent Application Publication
(10) Pub. No.: US 2004/0017336 A1
(43) Pub. Date: Jan. 29, 2004

(54) Driving method and system for light-emitting device

(76) Inventor: Yi-Chen Chang, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/064,881

(22) Filed: Aug. 27, 2002

(30) Foreign Application Priority Data
Jul. 24, 2002 (TW) 91116445

(51) Int. Cl. G09G 3/32

(52) U.S. Cl. 345/84

(57) ABSTRACT

A driving method for a light-emitting device, suitable for driving an active matrix organic light-emitting display. A driving circuit for a light-emitting device is provided to control the light-emitting device. The driving circuit has a data input terminal to receive a data signal corresponding to a complete frame, so as to control the luminescence status of the light-emitting device. A clock is provided and partitioned into a first clock and a second clock. The first clock and the second clock have the same frequency, while the first clock is delayed in relation to the second clock. Alternatively, the second clock can be delayed in relation to the first clock. The data signal is input to the data input terminal of the driving circuit at the first clock, while a reset signal is input to the data input terminal of the driving circuit at the second clock.

### CROSS REFERENCE TO RELATED APPLICATIONS

This application claims the priority benefit of Taiwan application serial no. 91116445, filed Jul. 24, 2002.

### BACKGROUND OF INVENTION

1. Field of the Invention

The invention relates in general to a display technique of a light-emitting device, and more particularly, to a driving method for an active matrix organic light-emitting diode (AMOLED) that increases the stability of the time-dependent threshold voltage.

2. Related Art of the Invention

Video products, particular the digitized video or image apparatus, has become a common appliance in daily life due to the development of high technology. The display is one of the most important devices in the digitalized video or image apparatus. The user can read information from the display, and control operation of the apparatus.

To comply with modern life style, video or image apparatus tend to be thinner and lighter. The traditional cathode ray tube, though it has certain advantages, occupies a large space and consumes high power. Therefore, optoelectronic technology and semiconductor fabrication techniques have developed the flat panel display such as the liquid crystal display or the active matrix organic light-emitting diode.

The technique of liquid crystal display has been developed for years without a significant breakthrough. The active matrix organic light-emitting diode thus has become one of the main streams for future development in flat panel display. The active matrix organic light-emitting diode uses thin-film transistor (TFT) techniques to drive the organic light-emitting diode. The driver IC is directly formed on the play to achieve light, thin, short and small volume, and the low cost requirement. The active matrix organic light-emitting diode can thus be applied as the display in cellular phones, personal data assistants (PDA), digital cameras, palm pilots, portable DVD players and vehicle navigating systems. In the future, the active matrix organic light-emitting diode can be further developed into large area displays such as the computer monitor and the television screen.

The display screen of the digitalized display is constructed by pixels arranged in dot matrix. To control the individual pixel unit, a scan line and a data line are used to select and apply an appropriate operation voltage to a specific pixel, such that the display information corresponding to the selected pixel is displayed. FIG. 1 shows a conventional driver circuit of an organic light-emitting diode for driving a pixel thereof. The driver circuit includes transistors 100 and 102, for example, thin-film transistors. The gate of the transistor 100 is connected to the scan line to receive a scan voltage Vscan at an appropriate clock, while the source thereof receives a data voltage Vdata from the data line at the same clock. The drain of the transistor 100 is coupled to the gate of the transistor 102. In addition, a storage capacitor 106 is coupled between the gate and source of the transistor 102. The drain of the transistor 102 is coupled to a voltage source V+, and the source of the transistor 102 is connected to an anode of an organic light-emitting device 104 in series. The cathode of the organic light-emitting device 102 is coupled to a relatively negative voltage V−.

In the driver circuit as shown in FIG. 1, when the gate of the transistor 100 is conducted by receiving the scan voltage Vscan from the scan line, the data voltage Vdata is input to the gate of the transistor 102 from the transistor 100. Thereby, the transistor 102 is also conducted. The voltage source V+ is then applied to the organic light-emitting device 104 via the transistor 102, so that light is generated by the organic light-emitting device 104. The transistor 102 is the driver device. Refer to FIG. 3, which illustrates the clock of the scan signal. A frame is defined between two consecutive clock pulses. A predetermined image data block is input to the corresponding pixel within the time of a frame. When the clock pulse of the scan line voltage Vscan activates the transistor 100, the data voltage Vdata also activates the transistor 102. Meanwhile, the data voltage Vdata is stored in the storage capacitor 106 to maintain the on status of the transistor 102.

Therefore, the conventional light-emitting device 104 is on in any frame. The variation is limited to the various display gray scales dependent on the data voltage Vdata. In other words, in the traditional design, the thin-film transistor active matrix organic light-emitting diode is emitting light all the time. The light-emitting status meets with the image display effect of which the flicker is eliminated. To continuously drive the light-emitting device, the transistor 102 is kept on continuously. For normal transistors 102, particularly the thin-film transistor, the long-time operation increases the threshold voltage. Consequently, the light-emitting status such as brightness or luminance of the light-emitting device is affected. The effect caused by deviation of the threshold voltage Vth of the driver circuit adapting the thin-film transistor is discussed as follows.

When the organic light-emitting device 104 is activated, the driving current I_{D} of the thin-film transistor can be derived from Formula (1)-(3):

$$\begin{matrix}{I}_{D} = \frac{1}{2} {k ( {V}_{gs} - {V}_{th} )}^{2} , & ( 1 ) \\ {I}_{D} = \frac{1}{2} {k ( {V}_{G} - {V}_{S} - {V}_{th} )}^{2} , & ( 2 ) \\ {V}_{S} = V + {V}_{OLED} , & ( 3 )\end{matrix}$$

where k is a characteristic constant for thin-film transistor. From the above formula, when the threshold voltage Vth is increased as the activating time, the driving current/_{D} of the light-emitting device 104 is reduced to affect the luminescent condition thereof. Normally, the brightness is decreased. The lifetime of the light-emitting device is also determined according to the luminescence condition. Therefore, the variation of the threshold voltage Vth is critical to the organic light-emitting device 104.

FIG. 2 shows the driver system of a thin-film transistor active matrix organic light-emitting display. A video control unit 120 is used to receive a video signal. The video control unit 120 includes a color-decoding unit 122 to extract an image signal from the video signal for performing R, G, B decoding. The decoded signal, after being processed by actual design, is temporarily stored in a buffer memory unit 124 to correspond with an image data of the current frame. A clock control chip 126 such as FPGA is used to extract image data from the buffer memory unit 124. According to the clock of the frame, the image signal is output to a driver circuit 130 of an active matrix light-emitting diode 128. As shown in FIG. 3, corresponding to the current frame, the data block (for example, the image information for each pixel in one row) is output to a plurality of corresponding pixels of the active matrix light-emitting diode 128 to display the image corresponding to the frame. The clock of the scan line is 60 Hz, for example. In the above conventional driving method, although the display 128 is maintained in a continuously on state, the continuously on state causes the deviation of threshold voltage Vth of the transistor 102. Consequently, the display quality is affected.

### SUMMARY OF INVENTION

The present invention provides a driving method of a light-emitting device to avoid the drift of threshold voltage caused by the continuously on state thereof.

The present invention further provides a driving method by which the threshold voltage of a driver transistor for driving a light-emitting device is kept as a stable value without changing the design of the driver circuit. As a result, the brightness of the long time luminescent light-emitting device is not reduced.

The driving method provided by the present invention is suitable for use in an active matrix light-emitting diode which comprises a driver circuit to control a light-emitting device. The driver circuit has a data input terminal for inputting at least a data signal corresponding to a complete frame, so as to control the luminescent state of the light-emitting device. A clock is provided and partitioned into a first clock and a second clock. The frequencies of the first clock and the second clock are the same. The first clock is delayed in relation to the second clock. Or alternatively, the second clock is delayed in relation to the first clock. At the first clock, the data signal is input to the data input terminal of the driver circuit. At the second clock, a reset signal is input to the data input terminal of the driver circuit.

The present invention further provides a driving method of an active matrix light-emitting diode. The active matrix light-emitting diode includes a video control unit to receive a continuous video signal with one frame as the unit. The input image display clock of the frame is decoded and processed into an image signal in a form of image display clock output to the active matrix light-emitting diode via a clock control unit. In the present invention, a reset clock is fixed after the clock control unit outputs the image signal and before the frame is changed. The reset signal corresponding to the frame is output to the active matrix light-emitting diode, such that the pixel units corresponding to the frame are temporarily switched off.

The present invention further provides an active matrix light emitting diode using a frame as unit to continuously receive a video signal. The frame is input as an image display clock. The system comprises at least a color decoding unit to extract an image signal of the video signal for performing decoding, a buffer memory and a clock control unit. The buffer memory unit is used to temporarily store an image data corresponding to the frame after the image signal is decoded and processed. The clock control unit is used to extract the image data from the buffer memory unit and to output the image signal to the active matrix light-emitting diode. After the clock control unit outputs the image data and before the frame is changed, a reset clock is fixed and output to the active matrix light emitting diode corresponding to the frame. Therefore, a plurality of pixels of the active matrix light-emitting diode corresponding to the frame is temporarily switched off.

The time difference between the rest clock and the image display clock is one half of the image display clock.

### BRIEF DESCRIPTION OF DRAWINGS

These, as well as other features of the present invention, will become more apparent upon reference to the drawings wherein:

FIG. 1 shows a schematic drawing of a driver circuit of a thin-film transistor active matrix organic light-emitting diode;

FIG. 2 is a block diagram of a thin-film transistor active matrix organic light-emitting diode;

FIG. 3 is a clock diagram of a scan signal;

FIG. 4 shows the block diagram of a driving system of a thin-film transistor active matrix organic light-emitting diode;

FIG. 5 shows the functional structure of the clock control block as shown in FIG. 4;

FIG. 6 shows the control clock diagram of the clock control block; and

FIG. 7 shows the driving method of the active matrix organic light-emitting diode.

### DETAILED DESCRIPTION

The present invention provides a driving method of a light-emitting device to avoid the threshold voltage drift under the continuously on state of the driving transistor that drives the light-emitting device continuously emitting light. In addition, the driving method of the light-emitting device maintains the threshold value at a stable value without changing the driver circuit design. The lifetime of the light-emitting diode is thus prolonged without reducing brightness.

Based on the consideration of persistence of vision for human eyes, the driver transistor can be switched off for a transient moment without affecting the vision effect. Thereby, the threshold voltage of the driver transistor is reset. The unstable drift of the threshold voltage caused by long-term on status is thus avoided.

According to the medical report, having persistence of vision, human eyes do not sense flickers when the flashing frequency of an image is higher than 60 Hz. This is why human eyes cannot discriminate the flicker for a light driven by an AC frequency of 60 Hz. When a frame is displaying an image, if the transient variation is faster than the variation of the frame, the light-emitting device of the corresponding pixels is switched off, so that human eyes cannot feel the dark picture flashing generated by the switching-off operation, though the total brightness may be reduced. The reduced brightness is easily adjusted to compensate the predetermined brightness. The reduced brightness is relatively minor.

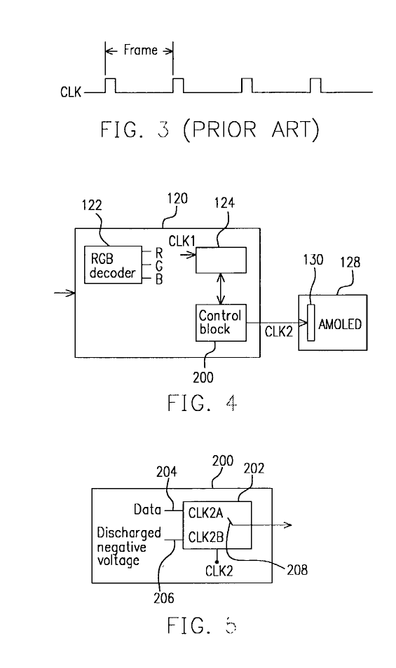

FIG. 4 shows a system block diagram of a thin-film transistor active matrix light-emitting display system. As shown in FIG. 4, the structures of the active matrix light-emitting diode are similar to that as shown in FIG. 2. In this embodiment, only the difference is discussed. The control block 200 is used to control variation of the clock. The input speed of a video signal is maintained at the first clock CLK1, and the video signal is temporarily stored in the buffer memory unit 124. The buffer memory unit 124 can be disposed external to or built in the control block 200. The first clock CLK1 is 60 Hz, for example. According to the definition in FIG. 3, the frame variation is the speed variation of the first clock CLK1.

FIG. 5 shows the functional structure of the clock control block as shown in FIG. 4. In FIG. 5, the control block 200 includes an output control unit 202 controlled by a second clock CLK2. The second clock CLK2 is a multiple of the first clock CLK1. Preferably, the second clock CLK2 is double of the first clock CLK1, that is, 120 Hz. The second clock CLK2 is partitioned into at least two clocks CLK2A and CLK2B. The frequency variation of the clocks CLK2A and CLK2B are the same as the first clock, that is, 60 Hz. However, the clocks CLK2A and CLK2B are delayed by a half of the period of the first clock CLK1. Therefore, when the first clock CLK1 is 60 Hz, the second clock CLK2 is 120 Hz. In FIG. 6 shows the control clock diagram of the clock control block. To match the clocks CLK2A and CLK2B to switch on and off the driver circuit, the clock of the scan line is preferably the second clock CLK2.

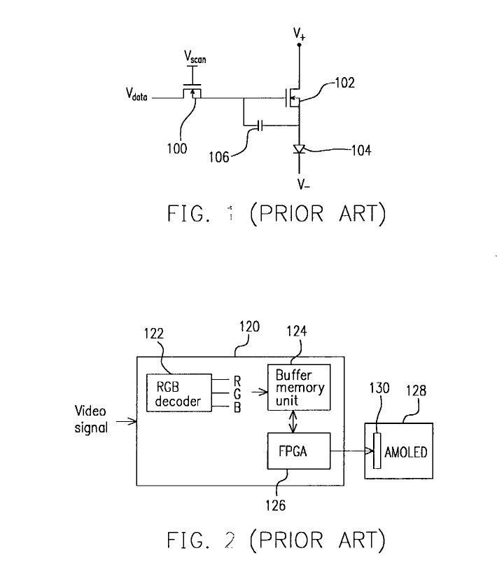

Generally speaking, the clocks CLK2A and CLK2B require only the same frequency of the frame or the first clock CLK1, while synchronism is not a criterion. For example, the image data Vdata is output at the clock CLK2 to control the light-emitting device of the display 128. At clock CLK2B, a discharged negative voltage corresponding to the current frame is output. The discharged negative voltage is a kind of reset signal that allows the driver transistor 102 in FIG. 1 to be switched off, such that the threshold value of the driver transistor 102 returns to the initial value. The clocks CLK2A and CLK2B are interchangeable. The following design provides a further description.

The output control unit 202 includes a switch 208, for example, and can obtain the image data from the buffer memory unit. The output control unit 202 can also receive a discharged negative voltage. The discharged negative voltage can also be generated automatically at the output control unit 202. The output control unit 202 outputs the image data 204 to the display 128 at the clock CLK2A and outputs a reset signal 206 to the display 128 at the clock CLK2B to reset each corresponding pixel of the threshold voltage of the driver transistor. For FIG. 1, the reset signal 206 is a discharged negative voltage. The discharged negative voltage 206 is input as Vdata to the transistor 100 which is switched on at the second clock CLK2. Therefore, the discharged negative voltage 206 switches off the driver transistor 102. The switch between the image data 204 and the discharged negative voltage 206 is controlled by the switch 208. However, the switch 208 is not the only method for controlling the switching state. In terms of switching method, it can be set up to output the image data 204 at the clock CLK2B and to output the discharged negative voltage 206 at clock CLK2A.

According to the clock as shown in FIG. 6, the time when the light-emitting device 104 is on is only one half of a frame, so that the total brightness of the display 128 is decreased by one half. To reduce the time of the dark picture, the clock CLK2B can be selected at ⅔ of the frame, such that the time for having the dark picture is reduced to ⅓. Alternatively, the reduced brightness can also be compensated by many different ways easily.

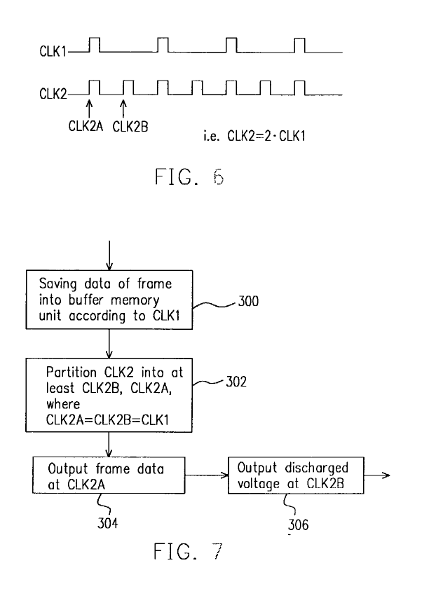

The present invention further provides a driving method for a light-emitting device as shown in FIG. 7. In step 300, a video signal saves an image data into a buffer memory unit 124 with a speed of the first clock CLK1. The first clock CLK1 defines the clock of the frame such as 60 Hz. In step 302, two clocks CLK2A and CLK2B are obtained by partition operation according to the second clock CLK2. The second clock CLK2 is a multiple of the first clock CLK1, for example. Preferably, the second clock CLK2 is double of the first clock CLK1. The frequencies of the first and second clock CLK1 and CLK2 are the same, while a delay exists between them. The delay is preferably ½ of the frame. In step 304, a frame image data 204 is output at the clock CLK2A. Meanwhile, a discharged negative voltage 206 is also output at the clock CLK2A. The image data 203 corresponding to the frame can also be output at the clock CLK2B, while the discharged negative voltage 206 is output at the clock CLK2A.

Accordingly, the present invention is characterized as:

1. a driving method for a light-emitting diode which avoids the threshold voltage drift of the driving transistor caused by the long-term on state of the driver transistor or the long-term emission state of the light-emitting diode.

2. a driving method for a light-emitting diode in which the threshold voltage of the driving transistor is maintained at a stable value without changing the circuit design, while the lifetime of the light-emitting device is prolonged without reducing the brightness thereof.

3. a driving method of a light-emitting diode in which a rest clock CLK2B is fixed after the image signal 204 is output with a clock CLK2A by the clock control unit 200 and before the frame is changed. The reset signal 206 corresponding to the frame is output to the active matrix light-emitting diode 128, allowing the pixels corresponding to the frame to be switched off temporarily. Therefore, the threshold voltage of the driver transistor 102 is prevented from being changed due to long-term on state.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

1. A driving method for a light-emitting device, suitable for use in an active matrix light-emitting display, comprising:
providing a driver circuit to control the light-emitting device, the driver circuit comprising a data input terminal for inputting a data signal, so as to control the light-emitting status of the light-emitting device;
providing a clock and partitioning the clock into a first clock and a second clock, wherein the first and the second clocks have the same frequencies but are asynchronous to each other;
inputting the data signal to the data input terminal of the driver circuit at the first clock; and
inputting the reset signal to the data input terminal of the driver circuit at the second clock.

2. The driving method according to claim 1, wherein the light-emitting device includes an organic light-emitting diode.

3. The driving method according to claim 1, wherein the frequencies of the first and second clocks are the same of an image display frequency set up by the active matrix light-emitting display.

4. The driving method according to claim 1, wherein the frequencies of the first and second clocks are 60 Hz.

5. The driving method according to claim 1, wherein the clock is double of the first clock.

6. The driving method according to claim 1, wherein the light-emitting device includes an organic light-emitting display to construct a thin-film transistor active matrix organic light-emitting diode display.

7. The driving method according to claim 1, wherein the reset signal temporarily switches off a driving transistor used to drive the light-emitting device.

8. The driving method according to claim 7, wherein the reset signal is used to switch on and off the light-emitting device.

9. The driving method according to claim 7, wherein the reset signal includes a negative voltage.

10. The driving method according to claim 1, wherein the reset signal enables a capacitor of the driver circuit to discharge, wherein the capacitor is used to maintain a voltage for switching a driving device of the driver circuit, so as to switch on the light-emitting device.

11. The driving method according to claim 1, wherein the data signal after being decoded and processed includes a plurality of gray scale signals corresponding to a plurality of pixels of the active matrix light-emitting display.

12. A driving method for a light-emitting device, applicable to an active matrix light-emitting display system that includes a video control unit receiving a continuous video signal with a frame as the unit, the frame being input with an image display clock, wherein the image display clock outputs an image signal to an active matrix light-emitting display via a clock control unit after performing a decoding and signal process, the driving method comprising:
fixing a reset clock after the clock control unit outputs the image signal and before the frame is changed, a reset signal corresponding to the frame is output to the active matrix light-emitting display to temporarily switch off a plurality of pixel units corresponding to the frame, wherein the pixel units use one frame as the unit to display an image of the frame.

13. The driving method according to claim 12, wherein the reset clock and the image display clock are spaced by a half clock of the image display clock.

14. The driving method according to claim 12, wherein the reset clock and the image display clock share a common clock by partitioning.

15. The driving method according to claim 14, wherein the common clock is double of the image display clock.

16. An active matrix light-emitting display system using a frame as a unit to continuously receive a video signal, wherein the frame uses an image display clock to input, the system comprising:
a color decoding unit, extracting an image signal from the video signal to perform decoding;
a buffer memory unit, temporarily storing an image data obtained by decoding and processing the image signal;
an active matrix light-emitting display;
a clock control unit, extracting the image data from the buffer memory unit, the clock control unit uses the image display clock to output the image signal to the active matrix light-emitting display;
wherein after the clock control unit outputs the image data and before the frame is changed, a reset signal corresponding to the frame is output to the active matrix light-emitting display to switch off a plurality of pixel units of the active matrix light-emitting display corresponding to the frame, wherein the pixel units use a frame as a unit to display an image of the frame.

17. The system according to claim 16, wherein the reset clock and the image display clock is spaced from each other by a half of the image display clock.

18. The system according to claim 16, wherein reset clock and the image display clock share a common clock by partitioning.

19. The system according to claim 16, wherein the common clock is double of the image display clock.

20. The system according to claim 16, wherein the clock control unit includes a chip to output the reset signal and the image data at the reset clock and the image display clock.
